(19) United States
(12) Patent Application Publication
(10) Pub. No.: US 2012/0120277 A1
(43) Pub. Date: May 17, 2012

(54) Multi-point Touch Focus

(75) Inventor: Richard Tsai, Cupertino, CA (US)

(73) Assignee: APPLE INC., Cupertino, CA (US)

(21) Appl. No.: 12/947,538

(22) Filed: Nov. 16, 2010

(51) Int. Cl. H04N 5/232; H04N 9/73

(52) U.S. Cl. 348/223.1; 348/333.11; 348/E05.047; 348/E09.052

(57) ABSTRACT

A camera includes a lens arranged to focus an image on an image sensor and a touch sensitive visual display for freely selecting two or more regions of interest on a live preview image by touch input. An image processor is coupled to the image sensor and the touch sensitive visual display. The image processor displays the live preview image according to the image focused on the image sensor by the lens. The image processor further receives the selection the regions of interest and controls acquisition of the image from the image sensor based on the characteristics of the image in regions that correspond to at least two of the regions of interest on the live preview image. The image processor may optimize sharpness and/or exposure of the image in at least two of the regions of interest. The image processor may track movement of the selected regions of interest.

### BACKGROUND

1. Field

Embodiments of the invention are generally related to image capturing electronic devices, having a touch sensitive screen for controlling camera functions and settings.

2. Background

Image capturing devices include cameras, portable handheld electronic devices, and electronic devices. These image capturing devices can use an automatic focus mechanism to automatically adjust focus settings. Automatic focus (hereinafter also referred to as “autofocus” or “AF”) is a feature of some optical systems that allows them to obtain and in some systems to also continuously maintain correct focus on a subject, instead of requiring the operator to adjust focus manually. Automatic focus adjusts the distance between the lens and the image sensor to place the lens at the correct distance for the subject being focused on. The distance between the lens and the image sensor to form a clear image of the subject is a function of the distance of the subject from the camera lens. A clear image may be referred to as “in focus,” “focused,” or “sharp.” More technically, focus is defined in terms of the size of disc, termed a circle of confusion, produced by a pin point source of light. For the purposes of the present invention, in focus means an image of a subject where the circle of confusion is small enough that a viewer will perceive the image as being acceptably clear.

A conventional autofocus automatically focuses on the center of a display (e.g., viewfinder) or automatically selects a region of the display to focus (e.g., selecting a closest object in the scene or identifying faces using face detection algorithms). Alternatively, the camera may overlay several focal boxes on a preview display through which a user can cycle and select, for example, with a half-press of button (e.g., nine overlaid boxes in the viewfinder of a single lens reflex camera). To focus on a target subject, a user also may center a focal region on the target subject, hold the focus, and subsequently move the camera so that the focal region is moved away from the target subject to put the target subject in a desired composition.

Similarly, image capturing devices can use an automatic exposure mechanism to automatically control the exposure. Automatic exposure (hereinafter also referred to as “autoexposure” or “AE”) is a feature of some image capturing devices that allows them to automatically sense the amount of light illuminating a scene to be photographed and control the amount of light that reaches the image sensor. Automatic exposure may control the shutter speed to adjust the length of time that light from the scene falls on the image sensor and/or the lens aperture to adjust the amount of light from the scene that passes through the lens. Some image capturing devices provide a flash, a high intensity light of a brief duration, to illuminate the subject when there is little available light or when it is desired to provide additional illumination in shadow areas (fill flash). Automatic exposure may control the amount of power delivered to the flash and other parameters to control the amount of light that reaches the image sensor when the flash is used.

Further, image capturing devices can use an automatic white balance and/or color balance mechanism to automatically control the relative amounts of the component colors in a captured image. White balance attempts to cause white or gray areas of the subject to be represented by a neutral color, generally by equal amounts of the component colors (e.g. equal amounts of red, green, and blue component values). Color balance attempts to cause particular areas of the subject to be represented by a color that is appropriate to the subject. Color balance is generally used when there are large areas of a scene having a similar color (e.g. blue sky or water or green grass). Color balance may be used to ensure that these areas are represented in the captured image with the desired color, which may or may not be an accurate reproduction of the scene (i.e. the sky may be made more blue or a lawn may be made more green).

As the automatic capabilities of image capturing devices increase, the possibilities for capturing images not as desired by the photographer also increase. It would be desirable to provide mechanisms that allow the photographer to provide indications of the characteristics desired in the image to be captured to improve the effectiveness of the automatic capabilities of the image capturing device.

### SUMMARY

A camera includes a lens arranged to focus an image on an image sensor and a touch sensitive visual display for freely selecting two or more regions of interest on a live preview image by touch input. An image processor is coupled to the image sensor and the touch sensitive visual display. The image processor displays the live preview image according to the image focused on the image sensor by the lens. The image processor further receives the selection the regions of interest and controls acquisition of the image from the image sensor based on the characteristics of the image in regions that correspond to at least two of the regions of interest on the live preview image. The image processor may optimize sharpness and/or exposure of the image in at least two of the regions of interest. The image processor may track movement of the selected regions of interest.

Several methods for operating a built-in digital camera of a portable, handheld electronic device are described. In one embodiment, the device receives a user selection (e.g., tap, tap and hold, gesture) of multiple regions of interest within a scene to be photographed as displayed on a display screen (e.g., touch sensitive display screen). A touch to focus mode may then be initiated to adjust the distance between the lens and the image sensor to obtain sharp images of the selected regions of interest. It is possible that the selected regions of interest will be at significantly different distances from the lens and the distance between the lens and the image sensor will be adjusted to a “compromise” distance to place the selected regions of interest as much in focus as the conditions of the scene allow.

The automatic white balance or color balance mechanism may adjust image parameters based on the selected regions of interest. While it is likely, though not necessary, that autofocus and autoexposure will both use the same regions of interest, the automatic balance mechanisms are more likely to use regions of interest selected specifically for the purpose of setting the white or color balance. Since color balance will generally not change rapidly or frequently, the balance may be set and then the regions of interest may be reset for focus and exposure. In other embodiments, the user may select multiple regions of interest and further select what parameters are controlled by the regions of interest.

### BRIEF DESCRIPTION OF THE DRAWINGS

The embodiments of the invention are illustrated by way of example and not by way of limitation in the figures of the accompanying drawings in which like references indicate similar regions. It should be noted that references to “an” or “one” embodiment of the invention in this disclosure are not necessarily to the same embodiment, and they mean at least one.

FIG. 1 shows a portable handheld device having a built-in digital camera and a touch sensitive screen, in the hands of its user undergoing a tap selection during an image capture process, in accordance with one embodiment.

FIG. 2 shows the portable handheld electronic device undergoing a multi-finger gesture during an image capture process, in accordance with an embodiment.

FIG. 3 shows a block diagram of an example, portable handheld multifunction device in which an embodiment of the invention may be implemented.

FIG. 4 is a flow diagram of operations in the electronic device during an image capture process, in accordance with one embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

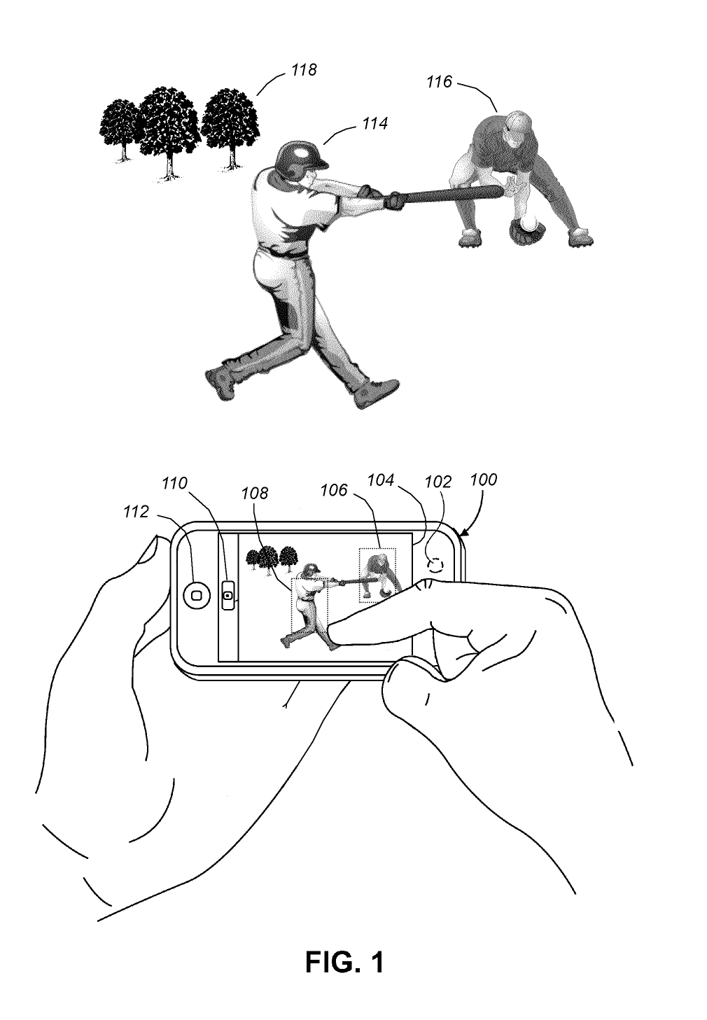

FIG. 1 is a pictorial view showing an image capturing device 100 in the hands of its user, undergoing a user selection (e.g., tap, tap and hold, gesture) during an image capture process. to capture a digital image. The device may be a digital camera or a mobile multifunction device such as a cellular telephone, a personal digital assistant, or a mobile entertainment device or any other portable handheld electronic device that has a built-in digital camera and a touch sensitive screen. Some aspects of the device, such as power supply, strobe light, zoom mechanisms, and other aspects that are not immediately relevant to the instant invention have been omitted to avoid obscuring the relevant aspects of the device.

The built-in digital camera includes a lens 102 located in this example on the back face of the device 100. The lens may be a fixed optical lens system or it may have focus and optical zoom capability. Although not depicted in FIG. 1, inside the device 100 are an electronic image sensor and associated hardware circuitry and running software that can capture digital images or video of a scene that is before the lens 102.

The digital camera functionality of the device 100 includes an electronic or digital viewfinder. The viewfinder displays live, captured video (e.g., series of images) or still images of the scene that is before the camera, on a portion of the touch sensitive screen 104 as shown. In this case, the digital camera also includes a soft or virtual shutter button whose icon 110 is displayed on the screen 104, directly to the left of the viewfinder image area. As an alternative or in addition, a physical shutter button may be implemented in the device 100. In one embodiment, the device 100 may be placed in either the digital camera mode or the mobile telephone mode, in response to, for example, the user actuating a physical menu button 112 and then selecting an appropriate icon on the touch sensitive screen 104. The device 100 includes all of the needed circuitry and/or software for implementing the digital camera functions of the electronic viewfinder, shutter release, and automatic image capture parameter adjustment (e.g., automatic exposure, automatic focus, automatic detection of a scene change) as described below.

In FIG. 1, the user can perform a selection of multiple regions of interest on the touch sensitive screen 104 as shown by, for example, tapping the screen with a stylus or finger or by gestures such as touch and drag. The user is able to freely position the selections of regions of interest on a preview portion of the touch screen without being limited to predefined areas. In some embodiments, the user may tap each region of interest 106, 108 to select a predefined area centered on the point of the tap. Tapping a region of interest may remove the selection. In other embodiments, a gesture such as tap and drag or pinch and depinch (spreading two pinched fingers) may be used to select both the location and size of a region of interest. Some embodiments may recognize both tapping to select predefined areas and gestures to select variably sized areas. The device may provide additional selections modes, such as single selection mode, as a selectable alternative to the multiple selection mode described here. While a rectangular selection is illustrated, the selection may be other shapes, such as circular or elliptical, in other embodiments. The device may allow the selection shape to be chosen by the user. In some embodiments, the device may permit the user to define a region of interest by drawing a freeform outline of the region.

A user can manipulate one or more graphical objects 106, 108 in the GUI 104 using various single or multi-finger gestures. As used herein, a gesture is a motion of the object/appendage making contact with the touch screen display surface. One or more fingers can be used to perform two-dimensional or three-dimensional operations on one or more graphical objects presented in GUI 104, including but not limited to magnifying, zooming, expanding, minimizing, resizing, rotating, sliding, opening, closing, focusing, flipping, reordering, activating, deactivating and any other operation that can be performed on a graphical object.

In the example shown in FIG. 1, the device 100 has detected the selection of two regions of interest and has drawn selection areas 106, 108 (in this case, the closed contour that has a box shape), centered around the location of each of the touch downs on the two subjects 114, 116. Once the user has finalized the selection of all regions of interest, the digital camera can be commanded to take a picture or record video. The image capture parameters are automatically adjusted based on at least two of the selected regions of interest. Acquisition of the image from the image sensor will be controlled based on the characteristics of the image on the image sensor in regions that correspond to two of the regions of interest on the live preview image when the controlled characteristic has a maximum and a minimum as will be discussed further below.

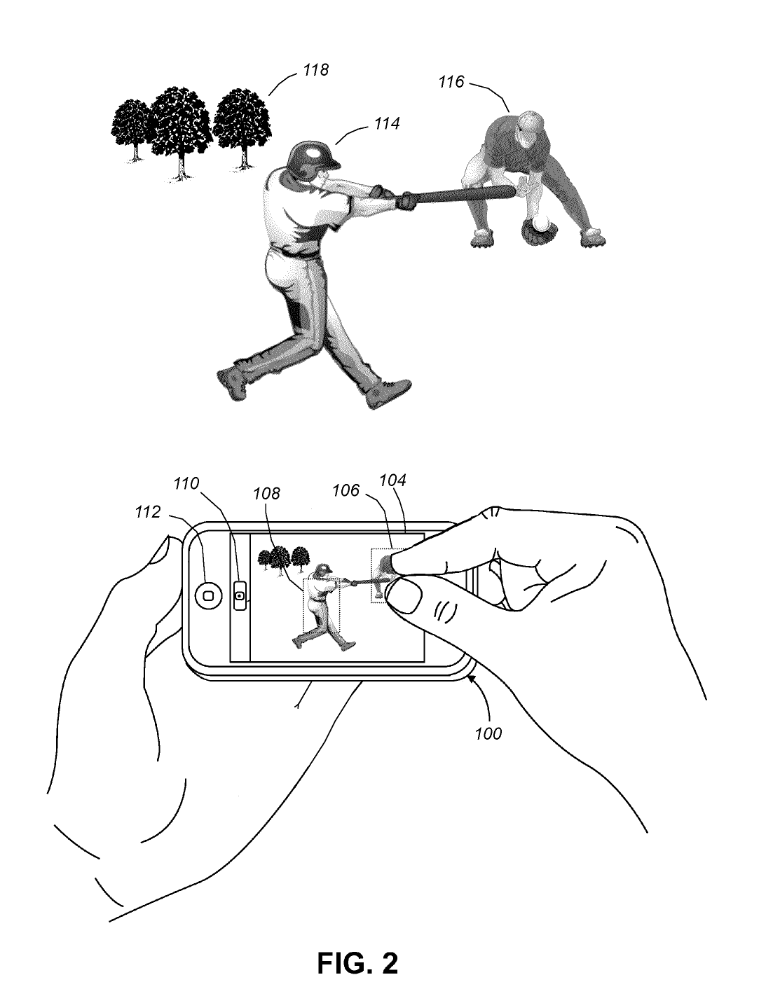

FIG. 2 shows the portable handheld electronic device undergoing a multi-finger gesture during an image capture process, in accordance with an embodiment. In particular, the thumb and index finger are brought close to each other or touch each other, simultaneously with their tips being in contact with the surface of the screen 104 to create two contact points thereon. The user positions this multi-touch gesture, namely the two contact points, at a location on the image of the scene that corresponds to an object in the scene (or portion of the scene) to which priority should be given when the digital camera adjusts the image capture parameters in preparation for taking a picture of the scene. In this example, the user has selected the location 106 where the fielder 116 appears on the screen 104.

In response to detecting the multi-touch finger gesture, the device 100 may cause a contour 106, in this example, the outline of a box, to be displayed on the screen 104, around the location of the detected multi-finger gesture. The contour 106 is a region of interest for setting image acquisition parameters. The user can then contract or expand the size of the metering area, by making a pinching movement or a spreading movement, respectively, with the thumb and index fingers while the fingertips remain in contact with the touch sensitive screen 104. The device 100 has the needed hardware and software to distinguish between a pinching movement and a spreading movement, and appropriately contracts or expands the size of the metering area. Gesture movements may include single or multi-point gestures (e.g., circle, diagonal line, rectangle, reverse pinch, polygon).

In some embodiments, the gestures initiate operations that are related to the gesture in an intuitive manner. For example, a user can place an index finger and thumb on the sides, edges or corners of the region of interest 106 and perform a pinching or spreading gesture by moving the index finger and thumb together or apart, respectively. The operation initiated by such a gesture results in the dimensions of the region of interest 106 changing. In some embodiments, a pinching gesture will cause the size of the region of interest 106 to decrease in the dimension being pinched. In some embodiments, a pinching gesture will cause the size of the region of interest 106 to decrease proportionally in all dimensions. In some embodiments, a spreading or de-pinching movement will cause the size of the region of interest 106 to increase in the dimension being depinched. In some embodiments, gestures that touch the sides of the region of interest 106 affect only one dimension and gestures that touch the corners of the region of interest 106 affect both dimensions.

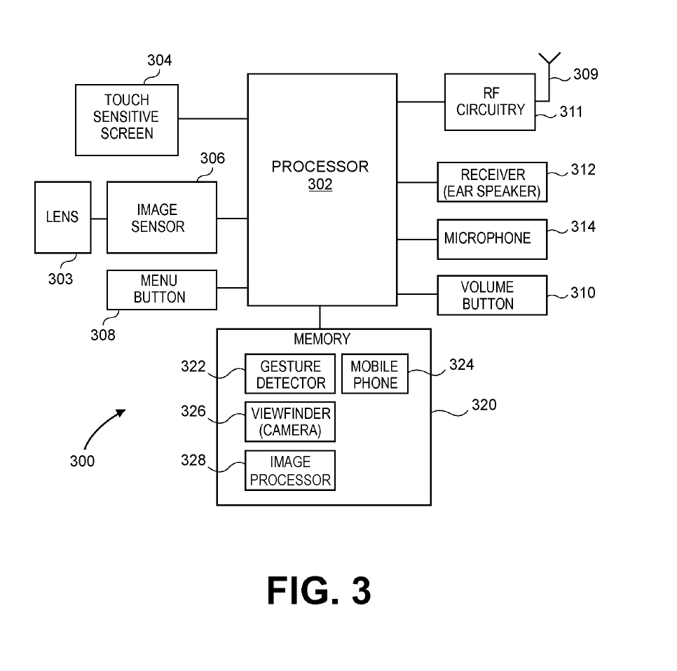

FIG. 3 is a block diagram of an exemplary image capture device 300, in accordance with an embodiment of the invention. The device 300 may be a personal computer, such as a laptop, tablet, or handheld computer. Alternatively, the device 300 may be a cellular phone handset, personal digital assistant (PDA), or a multi-function consumer electronic device, such as the IPHONE® device.

The device 300 has a processor 302 that executes instructions to carry out operations associated with the device 300. The instructions may be retrieved from memory 320 and, when executed, control the reception and manipulation of input and output data between various components of device 300. Memory 320 may be or include a machine-readable medium.

Although not shown, the memory 320 may store an operating system program that is executed by the processor 302, and one or more application programs are said to run on top of the operating system to perform different functions described below. A touch sensitive screen 304 displays a graphical user interface (GUI) to allow a user of the device 300 to interact with various application programs running in the device 300. The GUI displays icons or graphical images that represent application programs, files, and their associated commands on the screen 304. These may include windows, fields, dialog boxes, menus, buttons, cursors, scrollbars, etc. During operation, the user can select and activate various graphical images to initiate functions associated therewith.

The touch screen 304 also acts as an input device, to transfer data from the outside world into the device 300. This input is received via, for example, the user's finger(s) touching the surface of the screen 304. The screen 304 and its associated circuitry recognize touches, as well as the position and perhaps the magnitude of touches and their duration on the surface of the screen 304. These may be done by a gesture detector program 322 that may be executed by the processor 302. In other embodiments, an additional, dedicated processor may be provided to process touch inputs, in order to reduce demand on the main processor 302 of the system. Such a gesture processor would be coupled to the screen 304 and the main processor 302 to perform the recognition of screen gestures and provide indications of the recognized gestures to the processor 310. An additional gesture processor may also perform other specialized functions to reduce the load on the main processor 302, such as providing support for the visual display drawn on the screen 304.

The touch sensing capability of the screen 304 may be based on technology such as capacitive sensing, resistive sensing, or other suitable solid state technologies. The touch sensing may be based on single point sensing or multi-point or multi-touch sensing. Single point touch sensing is capable of only distinguishing a single touch, while multi-point sensing is capable of distinguishing multiple touches that occur at the same time.

Camera functionality of the device 300 may be enabled by the following components. An image sensor 306 (e.g., CCD, CMOS based device, etc.) is built into the device 300 and may be located at a focal plane of an optical system that includes the lens 303. An optical image of a scene before the camera is formed on the image sensor 306, and the sensor 306 responds by capturing the scene in the form of a digital image or picture or video consisting of pixels that will then be stored in the memory 320. The image sensor 306 may include an image sensor chip with several options available for controlling how an image is captured. These options are set by image capture parameters that can be adjusted automatically, by the image processor application 328. The image processor application 328 can make automatic adjustments (e.g., automatic exposure mechanism, automatic focus mechanism, automatic scene change detection, continuous automatic focus mechanism, color balance mechanism), that is without specific user input, to focus, exposure and other parameters based on selected regions of interest in the scene that is to be imaged.

In other embodiments, an additional, dedicated processor may be provided to perform image processing, in order to reduce demand on the main processor 302 of the system. Such an image processor would be coupled to the image sensor 306, the lens 303, and the main processor 302 to perform some or all of the image processing functions. The dedicated image processor might perform some image processing functions independently of the main processor 310 while other may be shared with the main processor.

The image sensor 306 collects electrical signals during an integration time and provides the electrical signals to the image processor 328 as a representation of the optical image formed by the light falling on the image sensor. An analog front end (AFE) may process the electrical signals provided by the image sensor 306 before they are provided to the image processor 328. The integration time of the image sensor can be adjusted by the image processor 328.

In some embodiments, the image capturing device 300 includes a built-in digital camera and a touch sensitive screen. The digital camera includes a lens to form optical images stored in memory. The touch sensitive screen, which is coupled to the camera, displays the images or video. The device further includes a processing system (e.g., processor 302), which is coupled to the screen. The processing system may be configured to receive multiple user selections (e.g., a tap, a tap and hold, a single finger gesture, and a multi-finger gesture) of regions of interest displayed on the touch sensitive screen. The processing system may be further configured to initiate a touch to focus mode based on the user selections. The touch to focus mode automatically focuses the subjects within the selected regions of interest. The processing system may be configured to automatically monitor a luminance distribution of the regions of interest for images captured by the device to determine whether a portion of a scene associated with the selected regions has changed.

The processing system may be configured to automatically determine a location of the focus area based on a location of the selected regions of interest. The processing system may be configured to terminate the touch to focus mode if the scene changes and to initiate a default automatic focus mode. For the default automatic focus mode, the processing system can set an exposure metering area to substantially full screen, rather than being based on the selected regions of interest. For the default automatic focus mode, the processing system can move a location of the focus area from the selected regions of interest to a center of the screen.

In one embodiment, an automatic scene change detect mechanism automatically monitors a luminance distribution of the selected regions of interest. The mechanism automatically compares a first luminance distribution of the selected region for a first image and a second luminance distribution of the selected region for a second image. Then, the mechanism automatically determines whether a scene has changed by comparing first and second luminance distributions of the selected region for the respective first and second images.

The device 300 may operate not just in a digital camera mode, but also in a mobile telephone mode. This is enabled by the following components of the device 300. An integrated antenna 309 that is driven and sensed by RF circuitry 311 is used to transmit and receive cellular network communication signals from a nearby base station (not shown). A mobile phone application 324 executed by the processor 302 presents mobile telephony options on the touch sensitive screen 104 for the user, such as a virtual telephone keypad with call and end buttons. The mobile phone application 324 also controls at a high level the two-way conversation in a typical mobile telephone call, by allowing the user to speak into the built-in microphone 314 while at the same time being able to hear the other side of the conversation through the receive or ear speaker 312. The mobile phone application 324 also responds to the user's selection of the receiver volume, by detecting actuation of the physical volume button 310. Although not shown, the processor 302 may include a cellular base band processor that is responsible for much of the digital audio signal processing functions associated with a cellular phone call, including encoding and decoding the voice signals of the participants to the conversation.

The device 300 may be placed in either the digital camera mode or the mobile telephone mode, in response to, for example, the user actuating a physical or virtual (soft) menu button 308 (e.g., 112 in FIGS. 1 and 2) and then selecting an appropriate icon on the display device of the touch sensitive screen 304. In the telephone mode, the mobile phone application 324 controls loudness of the receiver 312, based on a detected actuation or position of the physical volume button 310. In the camera mode, the camera application 328 can respond to actuation of a button (e.g., the volume button 310) as if the latter were a physical shutter button (for taking pictures). This use of the volume button 310 as a physical shutter button may be an alternative to a soft or virtual shutter button whose icon is simultaneously displayed on the display device of the screen 304 during camera mode and is displayed near the preview portion of the display device of the touch sensitive screen 304.

An embodiment of the invention may be a machine-readable medium having stored thereon instructions which program a processor to perform some of the operations described above. A machine-readable medium may include any mechanism for storing information in a form readable by a machine (e.g., a computer), not limited to Compact Disc Read-Only Memory (CD-ROMs), Read-Only Memory (ROMs), Random Access Memory (RAM), and Erasable Programmable Read-Only Memory (EPROM). In other embodiments, some of these operations might be performed by specific hardware components that contain hardwired logic. Those operations might alternatively be performed by any combination of programmed computer components and custom hardware components.

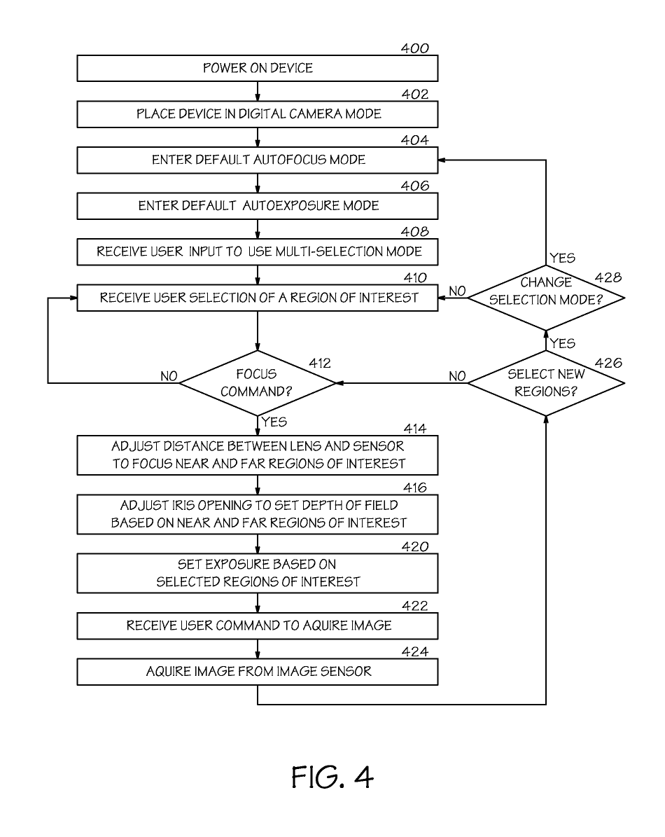

FIG. 4 is a flow diagram of operations in the electronic device during an image capture process, in accordance with one embodiment. After powering on the device 400 and placing it in digital camera mode 402, a view finder function begins execution which displays still images or video (e.g., a series of images) of the scene that is before the camera lens 102. The user aims the camera lens so that the desired portion of the scene appears on the preview portion of the screen 104.

A default autofocus mode is initiated 404 once the camera is placed in the digital camera mode. The default autofocus mode can determine focus parameters for captured images or video of the scene based on a default region of interest, typically an area at the center of the viewfinder. A default automatic exposure mode is initiated 406 which may set an exposure metering area to substantially the full-frame. The default automatic focus mode can set the focus area to a center of frame and corresponding center of the screen at block 406.

The user may initiate a multi-selection mode by providing an input to the device 408 such as a tap on an icon for the multi-selection mode. The user then selects a region of interest 410 by a gesture. The region of interest may be at any location on the preview portion of the screen 104. The gesture may be a tap that places a predefined region of interest centered on the tap location. In some embodiments, the image processor may define a region of interest that is a predicted region of pixels that are about coextensive with the location of the user selection. Alternatively, the selected region may be an object in the scene located at or near the location of the user selection, as detected by the camera application using digital image processing techniques. The gesture may be such that the user defines both the size and location of the region of interest. Gestures that may be used include, but are not limited to, multi-touch to touch two corners of the desired region, tap drag to tap one corner and drag to the diagonally opposite corner of the desired region, tap and drag to outline the desired region, or pinch and spread to compress and expand a selection.

Gestures may be used to delete a region of interest, such as tapping in the center of a selected region. Gestures may be used to move a region of interest, such as tapping in the center of a selected region and dragging to the desired location. As suggested by the arrow returning to the selection of a region of interest 412-NO, the user may repeat the selection process to select additional regions of interest until the user sends a command to start the acquisition of an image, such as a focus command. In some embodiments there is no limit to the number of regions of interest that a user may select while other embodiments may limit the number selected based on the number of regions that the image processor in the device can manage effectively.

It will be appreciated that a region of interest may move on the viewfinder due to camera movement and/or subject movement. The image processor may adjust the placement of regions of interest to track such movements.

The selection of regions of interest ends when a user command is received to adjust the focus 412-YES of the image to be acquired. The focus command may be part of a command to acquire an image, i.e. a shutter release, or a separate command. In other embodiments where the camera device has a fixed focus, the selection of regions of interest ends when another user command, such as acquire an image, is received.

It is possible that the subjects in the multiple regions of interest will be at different distances from the camera. For example, in the scene illustrated in FIG. 1, the batter 114 is closer to the camera 100 than the fielder 116. A subject that is closer to the camera will require that the lens be further from the image sensor for that subject to be in focus than is required to focus a subject that is further from the camera. Thus it is desirable to adjust the distance between the lens and the image sensor so that the near and far regions of interest, based on the distance between the subject in the region and the camera, are both reasonably in focus 414.

The image processor of the camera may employ a hill climbing type algorithm for focusing. When focusing on a single subject, a hill climbing algorithm adjusts the distance between the lens and the image sensor to maximize the contrast of the resulting image within the region of interest. Since contrast is higher when there are rapid changes between light areas and dark areas, contrast is maximized when the image is in focus. More specifically, the algorithm maximizes the high frequency components of the image by adjusting the focusing lens. In general, focused images have higher frequency components than de-focused images of a scene. One of measures for finding the best focusing position in the focus range is an accumulated high frequency component of a video signal in a frame/field. This measure is called the focus value. The best focusing position of the focus lens is obtained at the maximum position of the focus value. To focus on multiple regions of interest with subjects at various distances from the camera, a hill climbing algorithm can be used but it has to be adapted to arrive at a compromise focus in which both the near and far subjects are both reasonably in focus 414.

One possible algorithm determines a nearest and furthest region of interest, such as identifying the region of interest that comes into focus as all other regions go out of focus. If that occurs as the lens is moved away from the image sensor, then the last area to come into focus is the nearest region of interest. If that occurs as the lens is moved toward the image sensor, then the last area to come into focus is the farthest region of interest. The modified hill climbing algorithm may then move the lens toward a position that is between the distance from the image sensor to focus the nearest and the furthest regions of interest. For example, the modified hill climbing algorithm may move the lens to a compromise focus position where the ratio of the contrast for the compromise focus position to the contrast for the optimal position is the same for both the nearest and the furthest regions of interest. This may place both regions in an equally acceptable state of focus.

The selected regions of interest be of different sizes. For example, a region of interest for a far subject may be smaller than that for a near subject. The algorithm may weight selections of different sizes so that each region of interest receives equal weight for optimizing sharpness.

Another possible algorithm determines the distance between the lens and the image sensor for the near region of interest, v_{N}, and the far region of interest, v_{F}. The compromise focus position is then set such that the distance between the lens and the image sensor, v, is the harmonic mean of v_{N} and v_{F}:

$$v = \frac{2 {v}_{N} {v}_{F}}{{v}_{N} + {v}_{F}}$$

In other embodiments, the compromise focus position may be biased to make either the near or the far region of interest in somewhat better focus than the other region to improve the overall perception of sharpness of the image as a whole. The bias may be a function of the relative sizes of the region of interest. In some embodiments the compromise focus position may be approximated by the arithmetic mean, which results in a slight bias to the near region of interest:

$$v \approx \frac{{v}_{N} + {v}_{F}}{2}$$

The diameter of an aperture or iris that controls the passage of light through the lens to the image sensor affects the depth of field, the distance between a near and far object that are within a desired degree of focus. In embodiments where an adjustable iris is provided on the lens, the image processor may set the iris opening according to the distance between the near and far subjects 416 as reflected in the distance between the lens and the image sensor for the near region of interest, v_{N}, and the far region of interest, v_{F}. The f stop N, which is the ratio of the lens focal length to the iris diameter, may be set according to the desired circle of confusion c:

$$N \approx \frac{{v}_{N} - {v}_{F}}{2 c}$$

If the f stop is being set for close-up photography, where the subject distances approach the lens focal length, it may be necessary to consider the subject magnification m in setting the f stop:

$$N \approx \frac{1}{1 + m} \frac{{v}_{N} - {v}_{F}}{2 c}$$

The image processor also adjusts the exposure of the image based on the selected regions of interest 420. Unselected areas may be overexposed or underexposed so that the regions of interest receive a more ideal exposure.

The exposure may be set by controlling the length of time that light is allowed to fall on the image sensor or the length of time that the image sensor is made responsive to light falling on the image sensor, which may be referred to as shutter speed even if no shutter is actually used. It is desirable to keep the shutter speed short to minimize blurring due to subject and/or camera movement. This may require setting the f stop to a larger value than that determined based on focus to allow more light to pass through the lens. The image processor may perform a trade-off between loss of sharpness due to a larger f stop and a loss of sharpness due to expected blurring due to subject and/or camera movement.

In some circumstances, the camera may provide supplemental lighting, such as a camera flash. Camera provided illumination falls off in intensity in proportion to the square of the distance between the camera and the subject being illuminated. The image processor may use the distances to the regions of interest as determined when focusing the image to control the power of the supplemental lighting and the exposure of the image based on the expected level of lighting of the regions of interest.

Receipt of a user command to acquire an image 422 completes the image acquisition process by acquiring an image from the image sensor 424. The process of determining exposure may be initiated upon receipt of the user command to acquire an image or it may be an on-going process between the receipt of the user command to focus and image acquisition.

Following image acquisition the image processor determines if new regions are to be selected 426. The selection of new regions may be initiated based on a user command to clear the currently selected regions and/or a determination by the image processor that a new scene is in the viewfinder. If new regions are not to be selected 426-NO, then the process continues with the receipt of another command to focus on the scene 412.

If it is determined that new regions are to be selected 426-YES, then a further determination is made whether there is a change in the selection mode 428, e.g. ending the multi-selection mode. The multi-selection mode may be ended based on a user command to exit the multi-selection mode and/or a determination by the image processor that a new scene is in the viewfinder. If multi-selection is not ending 428-NO, then the process continues with the selection of new regions of interest 410. Otherwise 428-YES, the camera restores the default settings 404, 406 and awaits further commands from the user.

In an alternative embodiment, separate user selections can be used for adjusting the focus and controlling the exposure. For example, the user may be able to indicate whether a region of interest should control focus, exposure, or both.

The image processor may perform additional image adjustments based on multiple selected regions of interest. For example, the user may select regions that are neutral in color, e.g. white and/or shade of gray, and initiate a white balance operation so that that those areas are represented as neutral colors, such as having roughly equal levels of red, blue and green components, in the acquired image. Similarly, multiple selected regions of interest may be indicated as areas of a particular color, such as sky, water, or grass, in a color balance operation so that that those areas are represented as appropriate colors, which may or may not reflect the true colors of the subject, in the acquired image.

While certain exemplary embodiments have been described and shown in the accompanying drawings, it is to be understood that such embodiments are merely illustrative of and not restrictive on the broad invention, and that this invention is not limited to the specific constructions and arrangements shown and described, since various other modifications may occur to those of ordinary skill in the art. The description is thus to be regarded as illustrative instead of limiting.

What is claimed is:

1. A camera comprising:
an image sensor;
a lens arranged to focus an image on the image sensor;
a touch sensitive visual display;
an image processor coupled to the image sensor and the touch sensitive visual display, the image processor performing operations including
displaying a live preview image on the visual display according to the image focused on the image sensor by the lens,
receiving a selection of two or more regions of interest freely selected on the live preview image by touch input on the touch sensitive visual display, and
controlling acquisition of the image from the image sensor based on the characteristics of the image on the image sensor in regions that correspond to at least two of the regions of interest on the live preview image.

2. The camera of claim 1, further comprising a focus drive coupled to the lens and the image processor, the image processor controlling the focus drive to adjust a distance between the lens and the image sensor and thereby optimize sharpness of the image on the image sensor in regions that correspond to at least two of the regions of interest on the live preview image.

3. The camera of claim 2, wherein receiving the selection of two or more regions of interest further includes receiving a size of each of the regions of interest and selections of different sizes are weighted so that each region of interest receives equal weight for optimizing sharpness.

4. The camera of claim 1, further comprising an adjustable iris coupled to the lens and an iris drive coupled to the iris and the image processor, the image processor controlling the iris drive to adjust an opening diameter of the iris and thereby optimize sharpness of the image on the image sensor in regions that correspond to at least two of the regions of interest on the live preview image.

5. The camera of claim 1, wherein the image processor performs further operations to optimize exposure of the image on the image sensor in regions that correspond to at least two of the regions of interest on the live preview image.

6. The camera of claim 1, wherein the image processor performs further operations to adjust a color balance of the image on the image sensor in regions that correspond to the regions of interest on the live preview image.

7. The camera of claim 1, wherein the image processor performs further operations including tracking movement of the selected regions of interest.

8. An image processor for a camera, the image processor performing operations comprising:
receiving an image focused by a lens on an image sensor;
displaying a live preview image on a touch sensitive visual display according to the received image;
receiving a selection of two or more regions of interest freely selected on the live preview image by touch input on the touch sensitive visual display; and
acquiring the image from the image sensor based on the characteristics of the image on the image sensor in regions that correspond to at least two of the regions of interest selected on the live preview image.

9. The image processor of claim 8, performing further operations comprising adjusting a distance between the lens and the image sensor and thereby optimizing sharpness of the image on the image sensor in regions that correspond to at least two of the regions of interest on the live preview image.

10. The image processor of claim 9, wherein receiving the selection of two or more regions of interest further includes receiving a size of each of the regions of interest and weighting selections of different sizes so that each region of interest receives equal weight for optimizing sharpness.

11. The image processor of claim 8, performing further operations comprising adjusting an opening diameter of an iris coupled to the lens and thereby optimize sharpness of the image on the image sensor in regions that correspond to at least two of the regions of interest on the live preview image.

12. The image processor of claim 8, performing further operations comprising optimizing exposure of the image on the image sensor in regions that correspond to at least two of the regions of interest on the live preview image.

13. The image processor of claim 8, performing further operations comprising adjusting a color balance of the image on the image sensor in regions that correspond to at least two of the regions of interest on the live preview image.

14. The image processor of claim 8, performing further operations comprising tracking movement of the selected regions of interest.

15. A camera comprising:
means for receiving an image focused by a lens on an image sensor;
means for displaying a live preview image according to the received image;
means for receiving a selection of two or more regions of interest freely selected on the live preview image by touch input; and
means for acquiring the image from the image sensor based on the characteristics of the image on the image sensor in regions that correspond to at least two of the regions of interest selected on the live preview image.

16. The camera of claim 15, further comprising means for adjusting a distance between the lens and the image sensor and means for optimizing sharpness of the image on the image sensor in regions that correspond to at least two of the regions of interest on the live preview image by setting the distance between the lens and the image sensor.

17. The camera of claim 16, wherein the means for receiving the selection of two or more regions of interest further receives a size of each of the regions of interest and the means for optimizing sharpness weights selections of different sizes so that each region of interest receives equal weight for optimizing sharpness.

18. The camera of claim 15, further comprising means for adjusting an opening diameter of an iris coupled to the lens and means for optimizing sharpness of the image on the image sensor in regions that correspond to at least two of the regions of interest on the live preview image by setting the opening diameter of the iris.

19. The camera of claim 15, further comprising means for optimizing exposure of the image on the image sensor in regions that correspond to at least two of the regions of interest on the live preview image.

20. The camera of claim 15, further comprising means for adjusting a color balance of the image on the image sensor in regions that correspond to at least two of the regions of interest on the live preview image.

21. The camera of claim 15, further comprising means for tracking movement of the selected regions of interest.
